(19) United States
(12) Patent Application Publication
(10) Pub. No.: US 2013/0110697 A1
(43) Pub. Date: May 2, 2013

(54) FINANCIAL MARKET ACCELERATION EVALUATION TOOL

(71) Applicant: Diogenes Duzoglou, Caracas (VE)

(72) Inventor: Diogenes Duzoglou, Caracas (VE)

(21) Appl. No.: 13/531,634

(22) Filed: Jun. 25, 2012

Related U.S. Application Data
(63) Continuation-in-part of application No. 13/281,689, filed on Oct. 26, 2011.

(51) Int. Cl. G06Q 40/04

(52) U.S. Cl. 705/37

(57) ABSTRACT

A method for performing automated trading activities is disclosed. The method includes defining a take profit value and/or stop loss value for an initial position comprising an interest having an open-close value, receiving and storing historical market data and current market data pertaining to the initial position. The method further includes determining that a current open-close value of the interest is an outlier. The method further includes determining a probability that an open-close value of the interest reaches the take profit value or stop loss value within a predefined period of time, wherein the probability is greater than a threshold value. The method further includes transmitting an alert that the probability that the open-close value of the interest reaches the take profit value or stop loss value within the predefined period of time is greater than the threshold value.

### CROSS-REFERENCE TO RELATED APPLICATIONS

This patent application is a continuation-in-part of, and claims priority to, U.S. patent application Ser. No. 13/281,689, filed Nov. 10, 2011, titled “Multi-Level Automated Hedging Process.” The subject matter of U.S. patent application Ser. No. 13/281,689 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of finance, and more particularly relates to the fields of automated market analysis tools.

### BACKGROUND OF THE INVENTION

Having a predefined investment and/or trading strategy is crucial in the volatile financial industry. When performing investment and trading activities, it is common for the novice investor to be swept up in the emotions of the market. In the case of a plunging market, mass panic can spread, causing investors to sell. In a bull market, investors buy in large quantities. Performing in a reactionary manner, however, is widely regarded as a poor investment strategy. A much more effective approach is to pre-plan an investment strategy so that an investor's activities are pre-determined and not subject to the emotions associated with the highs and lows of the market.

One commonly-used approach to mitigating risk in the market involves defining a stop loss or a take profit. A stop loss is an order or a plan to sell a financial interest when it reaches a certain price. A stop loss is designed to limit an investor's loss on a position. A take profit is an order or plan specifying a price from the current price point where to close out a current position for a profit. A take profit is designed to lock in an investor's profit on a position. One of the drawbacks of current financial trading tools that allow for defining a stop loss or take profit is that once these items are defined, they cannot be modified during execution. This limits the flexibility of the stop loss and take-profit tools.

Another commonly-used approach to mitigating risk in the market involves hedging. A hedge is an investment activity that lower the risk associated with another investment activity. The idea behind a hedge is that an investor does not want to take on the full risk of a first investment activity. Consequently, the investor performs a second, less-risky investment activity that, when combined with the first activity, results in a lower risk endeavor. An example of a hedge is accompanying the purchase of a high-risk stock with the purchase of a low-risk stock, resulting in a collective trade of moderate risk. Currently, however, there are no widely available, automated solutions for implementing a predefined investment strategy that involves multiple and complex hedging activities. Further, there are no current solutions that execute trading activities with adequate speed and fidelity.

Another common problem in the financial industry is handling news and its effects on various markets. Market-related news comes in a wide variety of forms and types and can originate from a diverse selection of sources, from television and radio to blogs and text messages. On any given trading day, an immense amount of market-related news is broadcast, any of which can affect the price of financial interests in a variety of markets. Although there are certain causal patterns that may be deduced, the sheer amount of news, the large variety of news types and the fast pace of the financial markets make it difficult for investors to make trading decisions based on news.

An indicator that is often watched closely by traders is the volatility index. A volatility index refers to a value that represents the range of values that is usually exhibited by a particular financial interest or interests. A stock, a group of stocks, and an entire market, can all have respective volatility indexes associated with them. An interest with high volatility has large fluctuations in value, while an interest with a low volatility has smaller fluctuations in value. Currently, however, there are no widely available, automated solutions for implementing a predefined investment strategy that incorporates historical knowledge of volatility indexes of defined financial interests.

Therefore, a need exists to overcome the problems with the prior art as discussed above, and particularly for a more efficient way of automating the process of implementing stop loss and take profit orders in a trading environment.

### SUMMARY OF THE INVENTION

Automated trading tool with acceleration evaluation tools are provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

Briefly, according to an embodiment of the present invention, an automated method, computer system and computer-readable storage medium for performing automated trading activities is disclosed. The method includes defining a take profit value and/or stop loss value for an initial position comprising an interest having an open-close value, receiving and storing historical market data pertaining to the initial position. The method further includes receiving current market data pertaining to the initial position, and determining, according to the current market data and the historical market data, that a current open-close value of the interest is an outlier. The method further includes determining, according to the current acceleration rate for the open-close value and the take profit value or stop loss value, a probability that an open-close value of the interest reaches the take profit value or stop loss value within a predefined period of time, wherein the probability is greater than a threshold value. The method further includes transmitting an alert that the probability that the open-close value of the interest reaches the take profit value or stop loss value within the predefined period of time is greater than the threshold value.

### BRIEF DESCRIPTION OF THE DRAWINGS

The accompanying drawings, which are incorporated in and constitute a part of this disclosure, illustrate various example embodiments. In the drawings:

FIG. 1 is a block diagram illustrating the network architecture of a system for providing management of trading activities over a communications network, in accordance with one embodiment of the present invention.

FIG. 2 is a flow chart that shows the general control flow of a process for providing management of trading activities over a communications network, in accordance with one embodiment of the present invention.

FIG. 3 is a flow chart that shows the control flow of a process for providing management of trading activity scheduling over a communications network, in accordance with one embodiment of the present invention.

FIG. 4A is a flow chart that shows the control flow of a process for providing management of an investment strategy definition and execution over a communications network, in accordance with one embodiment of the present invention.

FIG. 4B is a flow chart that shows the control flow of a process for providing management of an investment strategy definition and trading activity over a communications network, in accordance with one embodiment of the present invention.

FIGS. 5A and 5B is a flow chart that shows the control flow of a more specific process for providing management of hedging activities over a communications network, in accordance with one embodiment of the present invention.

FIG. 5C is a flow chart that shows the control flow of a process for providing automated management of stop loss and/or take profit trading activities over a communications network, in accordance with one embodiment of the present invention.

FIG. 6 is a block diagram of a system including an example computing device for implementing the present invention.

### DETAILED DESCRIPTION OF THE PREFERRED EMBODIMENTS

It should be understood that the embodiments below are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

The present invention, according to a preferred embodiment, overcomes problems with the prior art by providing an improved system, method and computer program product for evaluating velocity and acceleration data and using it manage stop loss and take profit tools to facilitate trading activity in an automated fashion. The present invention improves upon the prior art by allowing for the predefined stop loss and take profit values to be adjusted in an automated fashion on-the-fly in response to the evaluation of velocity and acceleration data. This allows for the optimization of gains due to adjusted take profit value and the minimization of losses due to adjusted stop loss values.

The present invention further improves upon the prior art by providing an automatic stop loss and take profit management process that can be executed mechanically without user intervention, after initial definition. This allows users to automatically implement predefined investment strategies, thereby decreasing risk and increasing return of their existing investment strategies. This feature adds to the versatility of existing investment strategies and does not replace or modify an existing investment strategy.

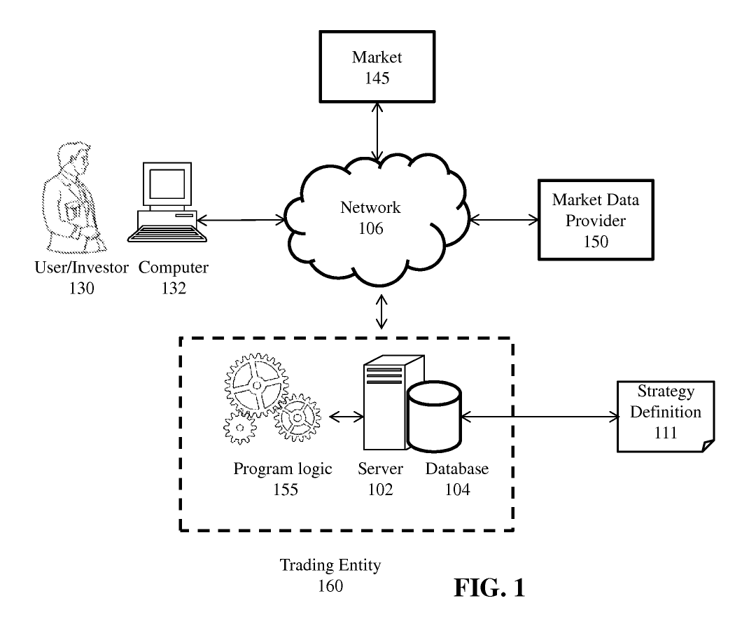

The present invention may be implemented in a computer system that may include a user/investor interface that connects with: 1) a trading entity (such as a financial services company), 2) a market, and 3) a market data provider that provides data about the market. Referring now to the drawing figures in which like reference designators refer to like elements, there is shown in FIG. 1 an illustration of a block diagram showing the network architecture of a system and method for providing management of automated trading activities over a communications network in accordance with the principles of the present invention. The central element of FIG. 1 is network 106, which can be a circuit switched network, such as the Public Service Telephone Network or a packet switched network such as the Internet or the World Wide Web.

FIG. 1 further includes computer 132, which may be a smart phone, mobile phone, tablet computer, handheld computer, laptop, or the like. Computer 132 corresponds to user/investor 130. FIG. 1 further shows trading entity 160 comprising one more servers 102 and attached database 104. The trading entity 160 may be a trading platform, which is a computer system that can be used to place orders for financial products over a network with a market, such as market 145. Trading platforms allow electronic trading to be carried out by users from any location. Trading entity 160 may alternatively be a financial services company with an online presence.

The financial products handled by entity 160 may include shares, bonds, equities, currencies, commodities, foreign currencies and derivatives with a financial intermediary, such as brokers, market makers, investment banks or stock exchanges. Financial products may also include equity, fixed-income, financial derivatives, currency, and other investment instruments. Financial products may further include participating in other exchanges such as a put, a put option, a short sell, a call or another type of offer or contract to buy or sell at certain predefined prices and/or times. The aforementioned financial products are herein referred to collectively as “interests.”

FIG. 1 further shows market 145, which may be any one of a variety of systems, institutions, procedures, social relations and infrastructures whereby parties engage in exchange. Examples of a market include stock markets, stock exchanges (such as the New York Stock Exchange), bond markets, commodities markets, currency markets, foreign exchange markets, derivatives markets, prediction markets, and money markets. FIG. 1 also includes market data provider 150, which provides market data about one or more markets. Market data is quote and trade-related data associated with financial products and interests. Market data is numerical price data, reported from trading venues, such as stock exchanges. Market data provider 150 may be a financial data vendor that provides data to financial firms, traders, and investors. The data distributed is collected from sources such as stock exchange feeds, brokers and dealer desks or regulatory filings (e.g., an SEC filing).

In one embodiment of the present invention, the term “market data” also includes what is typically referred to as “news.” News refers to the communication of selected information on current events, which is presented by print, broadcast, Internet, or word of mouth to consumers of the information. A subset of the general term “news” also includes financial news, which comprises, among other things, news, analysis and comment on securities, investment banking, asset management, hedge funds, private equity and trading.

In another embodiment of the present invention, the term “market data” also includes what is typically referred to as historical data. The term historical data may refer to old (i.e., not current) market data, including quote and trade-related data associated with financial products and interests, that pertains to a defined time period from the past. The historical market data may further include numerical price data, reported from trading venues, such as stock exchanges, financial news, and financial analysis and comment from an earlier period of time. The historical market data may also include historical volatility data for one or more interests. Volatility of an interest is a statistical measure of the dispersion of returns for a given interest. Volatility refers to the amount of uncertainty or risk about the size of changes in an interest's value. A higher volatility means that an interest's value can potentially be spread out over a larger range of values. A lower volatility means that an interest's value does not fluctuate dramatically, but changes in value at a steady pace over a period of time.

It should be noted that although FIG. 1 shows only one investor 130, one computer 132, one trading entity 160, one market 145 and one market data provider 150, the system of the present invention supports any number of investors, computers, trading platforms, markets and market data providers connected via network 106.

Computer 132 and/or server 102 includes program logic 155 comprising computer source code, scripting language code or interpreted language code that is compiled to produce computer instructions that perform various functions of the present invention. The program logic 155 may reside on client computer 132, the server 102 or any combination of the two. Preferably, the program logic 155 embodies: 1) a computer program for aiding a user 130 in defining an investment strategy, 2) an investment strategy embodied in a computer program, or a reasonable facsimile, by the user 130 or with his aid, with or without the aid of the computer program, 3) a computer program for implementing an investment strategy definition, 4) a computer program for implementing and/or executing trading activities and/or 5) any combination of the preceding elements. In another embodiment, the program logic embodies: 1) a computer program for collecting and storing market data, 2) a computer program for generating metadata based on the market data (as defined below), 3) a computer program for scheduling market actions or activity based on the metadata and current market data, 4) a computer program for implementing scheduled market actions or activity, and/or 5) any combination of the preceding elements.

Note that although computer 132, server 102, database 104, market 145 and market data provider 150 are shown as single and independent entities, in one embodiment of the present invention, the functions of the aforementioned entities may be integrated with one another in different combinations and permutations. Further, computer 132, server 102, database 104, market 145 and market data provider 150 and their functionalities, according to a preferred embodiment of the present invention, can be realized in a centralized fashion in one computer system, or in a distributed fashion where different elements are spread across several interconnected computer systems.

The present invention revolves around the implementation of an investment strategy defined by the user 130, preferably on a computer readable medium. The definition of an investment strategy (i.e., an investment strategy definition 111) may define a scenario when an initial position must be executed or taken. A scenario may be defined by one or more times or dates, one or more prices for one or more interests, one or more identifiers for interests to purchase, and other related data. A scenario may also define an initial position that must be taken when one or more scenarios occur. An initial position may include the purchase, sale or trade of an interest. For example, a scenario may define a threshold price for a certain stock after a certain date. When the aforementioned scenario is detected, the initial position is taken. Therefore, an investment strategy definition may be defined as a set of if-then statements, wherein the if-portion of the statement defines a scenario and the then-portion defines responsive positions that are taken when the scenario occurs.

The investment strategy definition may be fully defined by the user 130, with or without the aid of a computer program, and stored on a computer readable medium in database 104, though it may also be stored in computer 132. If aided by the computer program, when defining an investment strategy definition, the present invention may solicit certain information from the investor 130, such as his level of tolerance to certain fluctuations in the market, his risk status, his level of knowledge and/or experience with regard to particular markets and trading, his investment strategy's historical win/loss rate and/or win/loss amounts, the amount of capital or money he would like to risk losing (per time period, per position taken, etc.), the amount of gain he intends to realize (per time period, per position taken, etc.), the amount of loss he is comfortable realizing (per time period, per position taken, etc.), the amount of time he would like to hold each position and the amount of time he has available to participate in the investment activities. The present invention may also take other data into account, such as market data. An inference engine or expert advisor may provide an automated method for soliciting the aforementioned information from the investor 130. The investment strategy definition may further comprise defining a pair of commodities or currencies, which are bought or sold—or simply traded—against each other.

In addition to the data described above, the user 130 may further define certain data that are used by the program logic 155 of the present invention when executing its multi-tiered or multi-leveled hedging actions. This data may also be stored in the strategy definition 111. The user 130, may, for example, specify the dollar amount or size of each tier or level of hedging position taken, the amount of money he would like to risk losing (per time period, per position taken, per tier or level, etc.), the amount of gain he intends to realize (per time period, per position taken, per tier or level, etc.), the amount of loss he is comfortable realizing (per time period, per position taken, per tier or level, etc.), and the amount of time he would like to hold each level of hedging position.

In one embodiment, the if-portions of the if-then statements of the investment strategy definition 111 define when observation of a particular interest will begin. For example, the if-portion of an if-then statement may define a preset static time value, such as 9 am on 01-12-2011. In another example, the if-portion of an if-then statement may define a dynamic time value that is dependent on another event, such as 2 hours from opening of the market on Jan. 12, 2011. In yet another example, the if-portion may define a static value for an interest, referred to as an index interest, such as $2 per share for stock ticker symbol ABC. In other examples the if-portion may define: a value for a group of interests, a value delta for one or more interests, a particular type or frequency of a new item, a time after any of the above items or any combination of the above items.

In this embodiment, when a match is made between market data and the if-portion(s) of at least one of the if-then statements of the investment strategy definition 111, program logic 155 starts observing the interest defined in the then-portion of at least one of the if-then statements of the investment strategy definition 111. The time at which observation of the interest commences is referred to as the initial time. Recall that each if-then statement of the investment strategy definition 111 may include an interest that must be observed for a value delta before executing the trading activity in the then-portion of the statement. A value delta is a difference in the value of an interest, such as $1 for a particular stock. Thus, the trading activity defined in the then-portion of the statement occurs only after the interest has experienced the value delta, i.e., when the interest has changed in value an amount at least equal to the value delta.

Hedging actions may also be defined as a set of if-then statements, wherein the if-portion of the statement defines a scenario and the then-portion defines responsive hedging positions that are taken when the scenario occurs. Multiple levels of hedging actions may be defined in the strategy definition file 111 and stored in database 104. Additionally, there must be one or more scenarios that define when positions, whether it is an initial position or a hedge position, must be exited. This is referred to as a terminator action, which may also be defined as a set of if-then statements, wherein the if-portion of the statement defines a scenario and the then-portion defines a command to exit a position. If, for example, a current position comprises holding ownership of a stock or bond, then the exiting (or terminator) action for the current position would comprise selling the stock or bond. This terminator action data is defined in the strategy definition file 111 and stored in database 104.

Further, news-triggered trading actions may also be defined as a set of if-then statements, wherein the if-portion of the statement defines a scenario and the then-portion defines trading actions that are taken when the scenario occurs and a timeline or future date for those trading actions. Trading actions responsive to new-related market data may be defined in the strategy definition file 111 and stored in database 104. Future dates or a timeline for the trading actions may be defined in the strategy definition file 111 and stored in database 104.

The computer program of the present invention may receive and monitor market data, which may be provided by market data provider 150 and/or market 145. The computer program may search the market data for the at least one scenario of the definitions defined in file 111 and seek to match the market data with the at least one scenario defined in the aforementioned definitions. Responsive to matching the market data with the at least one scenario, the computer program executes the actions described in the definitions. In other words, the computer program executes the if-then statements of the definitions.

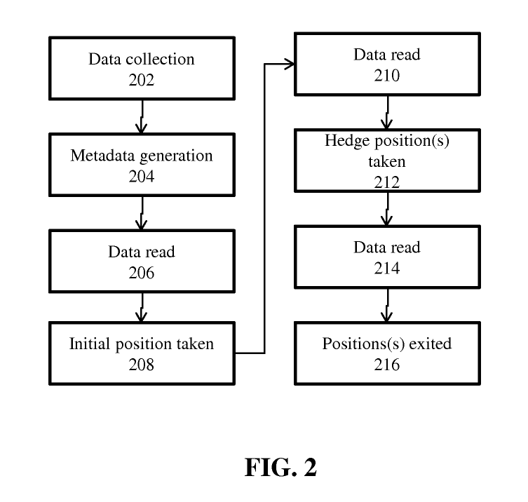

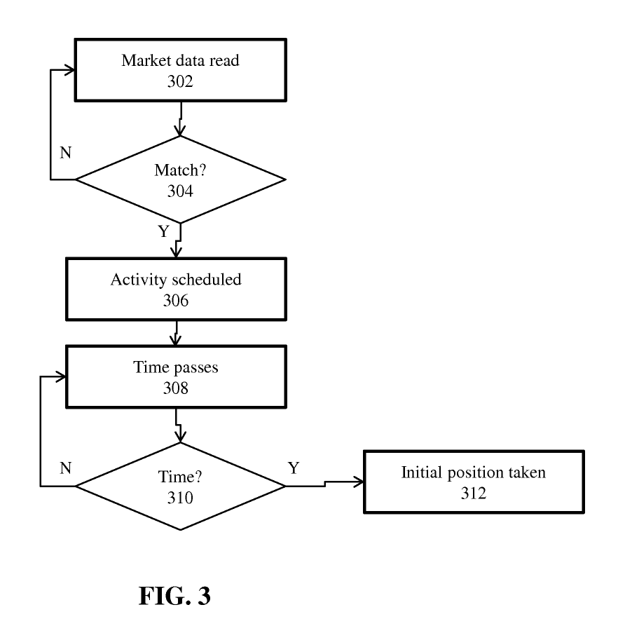

FIG. 2 is a flow chart that shows the general control flow of a process for providing management of trading activities over a communications network, in accordance with one embodiment of the present invention. FIG. 2 provides a broad description of the steps of the present invention, wherein more specific descriptions are provided with FIGS. 3 through 5.

In a first step 202, the program logic 155 collects market data from the market data provider 150. This includes a collection of news related market data. In addition to the type of data that may be collected from market data provider 150, the program logic 155 may also collect the following data about each news item and/or collections of new items: the type of news item, the date of the news item, the substance or subject matter of the news item, a summary of the news item, a source of the news item, an author of the news item, a publication or publisher of the news item, an identification of one or more news items that preceded the news item, an identification of one or more news items that are related to the news item, or the like. The data collected in step 202 may be stored in database 104.

In one alternative, in step 202, the program logic 155 collects historical market data from the market data provider 150. This includes market data for all or a subset of financial products and interests dating back before the current date and time. The historical market data may include data pertaining to open-close values of financial interests. An open-close value is defined as the close price of a financial interest minus the open price. For example, if the price of a currency X is $1.00 at the moment the trading day in a currency exchange opened, and the price of the currency X is $1.50 at the moment the trading day closed, then the open-close value is $0.50.

The historical market data can be used to determine certain data used in the investment strategy definition. For example, the historical market data can be used to define how the price of certain interests fluctuate in response to certain other indicators such as the prices of other interests and news stories. In another example, the historical market data can be used to define historical volatility data that defines how much one or more interests typically change in value over a set period of time. A volatility index of an interest represents how much that interest historically changes in value during a fluctuation over a set period of time. The data collected in step 202 may be stored in database 104.

In step 204, metadata about the market data collected in step 202 is generated. Based on the historical and empirical data collected in step 202, the program logic 155 may generate the following metadata about open-close values: acceleration rates, velocity rates, frequency and duration of acceleration and velocity rates, statistics pertaining to acceleration and velocity rates, etc. Further, based on the historical and empirical data collected in step 202, the program logic 155 may generate the following metadata about each news item and/or collections of new items: the category or level of the impact on one or more interests that is predicted due the news item, an identification of the interests that are predicted to be affected by the news item, the amount of fluctuation predicted in the price or valuation of one or more interests based on historical data, dates and times associated with price/valuation fluctuations that are predicted, and timelines for the price/valuation fluctuations that are predicted.

Also in step 204, news-triggered trading actions may also be defined based on the metadata that was generated. News-triggered trading actions may be defined as a set of if-then statements, wherein the if-portion of the statement defines a scenario and the then-portion defines trading actions that are taken when the scenario occurs and a timeline or future date for those trading actions. Trading actions responsive to new-related market data may be defined in file 111 and stored in database 104. Future dates or a timeline for the trading actions may be defined in a file 111 and stored in database 104.

In one embodiment of step 204, based on the historical and empirical data collected in step 202, the program logic 155 may generate a volatility index for one or more defined interests. The volatility index of an interest may be used (such as by program logic 155) to define (or to calculate) a value delta for that interest, wherein a value delta is a difference in the value of an interest. A value delta represents a movement in the price of an interest, wherein the movement may indicate that the interest may be on its way to moving its typical amount, i.e., its volatility index. Thus, as explained more fully below, when the value of an interest has moved by the amount of the value delta, there may be a higher possibility that the value of the interest may be moving its historical amount. This prediction may be used to define when an initial position is taken in the interest, as executed in step 208.

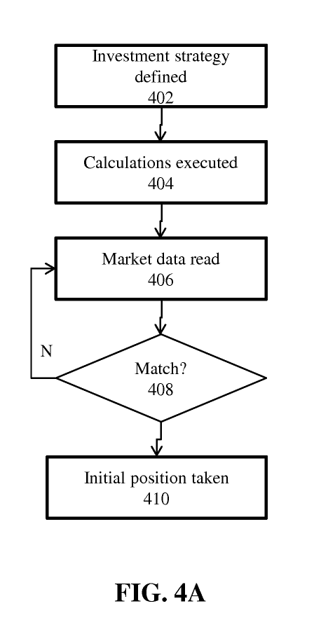

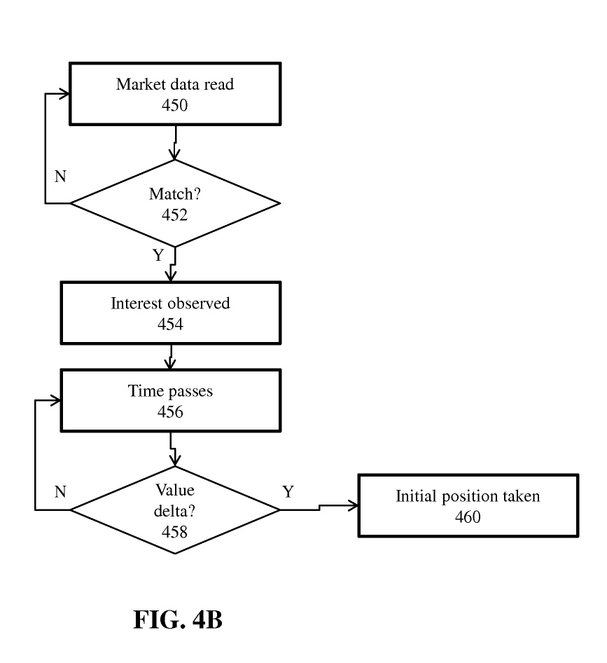

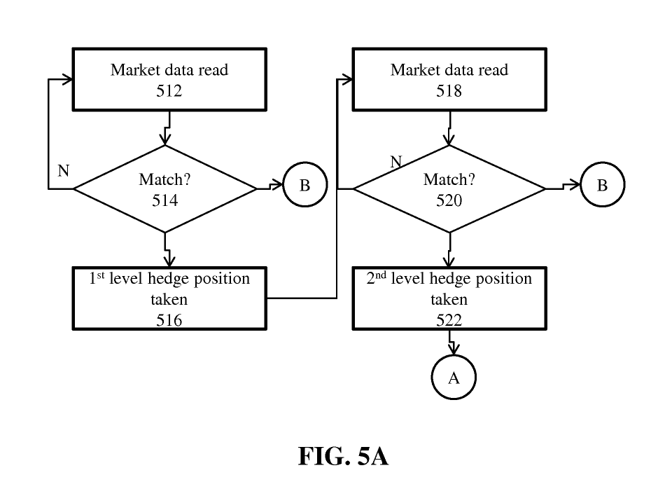

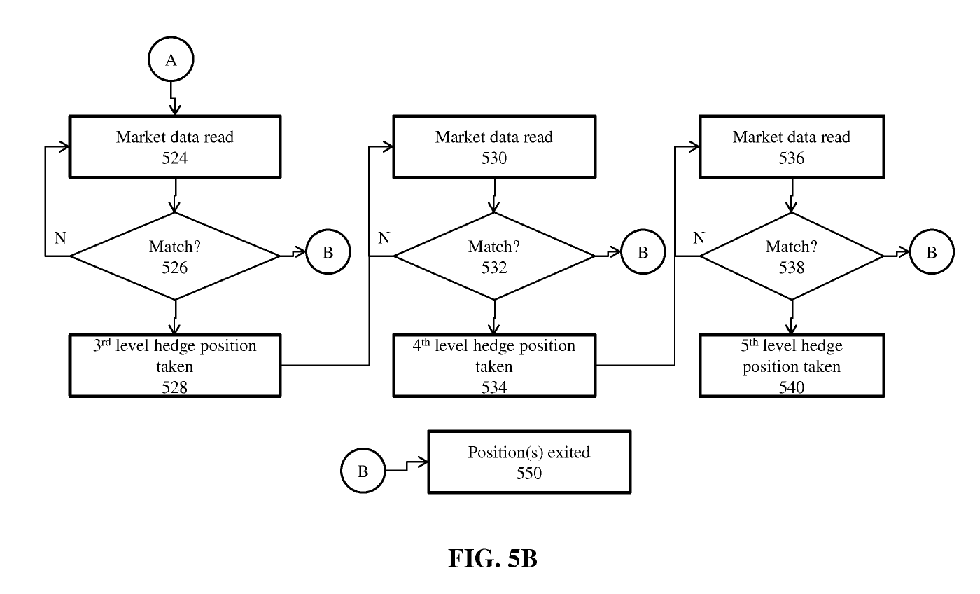

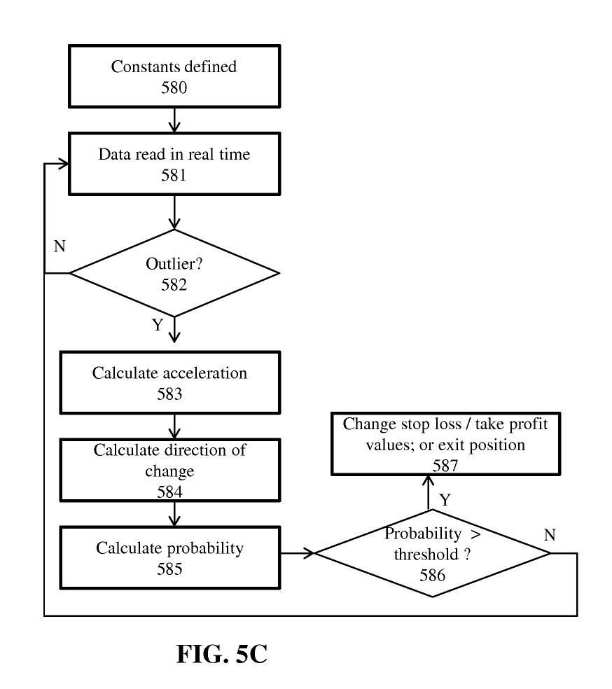

In step 206, market data is continually read by program logic 155 and in step 208, an initial position in the market 145 is taken. FIGS. 3 and 4A, 4B provide more detail on the process for taking an initial position. In step 210, market data continues to be read by program logic 155 and in step 212, one or more hedge positions are taken in the market 145. FIGS. 5A and 5B provide more detail on the process for taking one or more hedge positions. In step 214, market data continues to be read by program logic 155 and in step 216, all positions taken in the market 145 are exited or terminated. FIGS. 5A and 5B provide more detail on the process for exiting or terminating positions.

FIG. 3 is a flow chart that shows the control flow of a process for providing management of news analysis and activity scheduling over a communications network, in accordance with one embodiment of the present invention. FIG. 3 provides more detail on the process for taking an initial position, as shown in step 208 of FIG. 2.

In step 302, the program logic 155 continuously reads the market data received from market 145 and/or market data provider 150 and attempts to match the market data to the if-portions of the if-then statements of file 111. In step 304, the program logic 155 determines whether a match is made. If a match is made, the control flows to step 306. Otherwise, control flows back to step 302.

In step 306, a match was made between the market data and the if-portion(s) of at least one of the if-then statements of the file 111, and therefore program logic 155 schedules the trading activity defined in the then-portion of at the least one of the if-then statements of the news definition. Recall that each if-then state of the file 111 includes a date/time and/or timeline for executing the trading activity in the then-portion of the statement. Thus, the defined trading activity is scheduled, or placed on a calendar so as to occur at the predefined time/date. In step 308, a predefined period of time passes. In step 310 it is determined whether the date/time for executing the trading activity that was scheduled in step 306 has been reached. If the date/time has been reached, then control flows to step 312. Otherwise, control flows back to step 308.

In step 312, the trading activity that was scheduled in step 306 is executed, thereby assuming an initial position in the market. A position is generally considered taking ownership of an “interest,” as defined above. For example, the then-statement may comprise a command to purchase a certain number of shares of a particular stock or a certain amount of a currency.

FIG. 4A is a flow chart that shows the control flow of a process for providing management of an investment strategy definition and execution over a communications network, in accordance with one embodiment of the present invention. FIG. 4A provides more detail on the process for taking an initial position, as shown in step 208 of FIG. 2. Note that the process of FIG. 4A is an alternative to the process of FIG. 3.

In a first step 402, the user 130 utilizes his computer 132 to define his investment strategy definition 111. As described above, the investment strategy may comprise if-then statements, as well as other data. In step 404, the program logic 155 performs certain calculations based on the data entered by the user 130 in his investment strategy definition 111, wherein the calculations are later used to perform hedging actions. Examples of the calculations made by the program logic 155 in step 404 are described below.

The program logic 155 may calculate the number of transactions or operations (Ts) that will be executed over the amount of time defined by the user 130, as defined by the following equation:

Ts=(Ds×Op)

wherein Ds is the number of trading days over the amount of time defined by the user and Op is the average number of trading opportunities that arise each trading day for taking a market position.

The program logic 155 may also calculate the amount of money that may be traded per transaction (Pt) or operation over the amount of time defined by the user, as defined by the following equation:

Pt=Lc/Ts

wherein Lc represents the amount of money the user may comfortably lose, and Ts is the number of transactions or operations that will be executed over the amount of time defined by the user 130.

The program logic 155 may further calculate the amount of money that is predicted to be gained or lost based on the user's historical win/loss rate corresponding to his investment strategy definition 111, as defined by the following equations:

Predicted Gain=(% WinRate×Ts)×Pt

Predicted Loss=(% LossRate×Ts)×Pt

wherein % WinRate and % LossRate represents the historical win rate and loss rate of the user's predefined investment strategy.

In one embodiment of the present invention, additionally in step 404, hedge definitions and terminator actions may be generated and stored in database 104 based on: a) the data that was collected from the user 130 in step 402 and/or b) the calculations defined for step 404. In another embodiment of the present invention, additionally in step 404, hedge definitions and terminator actions may be generated and stored in database 104 based on predefined data not related to the data entered by the user 130. In this embodiment, hedge definitions and terminator actions may be generated based on empirical data of the market 145, such as the data collected and stored in step 202 and the metadata generated in step 204.

In step 406, the program logic 155 continuously reads the market data received from market 145 and/or market data provider 150 and attempts to match the market data to the if-portions of the if-then statements of the investment strategy definition 111 of user 130. In step 408, the program logic 155 determines whether a match is made. If a match is made, the control flows to step 410. Otherwise, control flows back to step 406.

In step 410, a match was made between the market data and the if-portion(s) of at least one of the if-then statements of the investment strategy definition 111 of user 130, and therefore program logic 155 executes the then-portion of at the least one of the if-then statements of the investment strategy definition, thereby assuming an initial position in the market.

FIG. 4B is a flow chart that shows the control flow of a process for providing management of an investment strategy definition and trading activity over a communications network, in accordance with one embodiment of the present invention. FIG. 4B provides more detail on the process for taking an initial position, as shown in step 208 of FIG. 2. Note that the process of FIG. 4B is an alternative to the processes of FIG. 3 and FIG. 4A.

In step 450, the program logic 155 continuously reads the market data received from market 145 and/or market data provider 150 and attempts to match the market data to the if-portions of the if-then statements of the investment strategy definition 111. In step 452, the program logic 155 determines whether a match is made. If a match is made, the control flows to step 454. Otherwise, control flows back to step 450.

In the process of FIG. 4B, the if-portions of the if-then statements of the investment strategy definition 111 define when observation of a particular interest will begin. In one embodiment, the if-portion of an if-then statement may define a preset static time value, such as 9 am on Jan. 12, 2011. In another embodiment, the if-portion of an if-then statement may define a dynamic time value that is dependent on another event, such as 2 hours from opening of the market on Jan. 12, 2011. In yet another embodiment, the if-portion may define a static value for an interest, referred to as an index interest, such as $2 per share for stock ticker symbol ABC. In other embodiments the if-portion may define: a value for a group of interests, a value delta for one or more interests, a particular type or frequency of a new item, a time after any of the above items or any combination of the above items.

In step 454, a match was made between the market data and the if-portion(s) of at least one of the if-then statements of the investment strategy definition 111, and therefore program logic 155 starts observing the interest defined in the then-portion of at least one of the if-then statements of the investment strategy definition 111. The time at which observation of the interest commences is referred to as the initial time. Recall that each if-then statement of the investment strategy definition 111 may include an interest that must be observed for a value delta before executing the trading activity in the then-portion of the statement. A value delta is a difference in the value of an interest, such as $1 for a particular stock. Thus, the trading activity defined in the then-portion of the statement occurs only after the interest has experienced the value delta, i.e., when the interest has changed in value an amount at least equal to the value delta. In one example, an if-then statement may state that if stock ticker symbol ABC changes in value $1, then a trading activity must be executed. When observation of the ABC stock commences (as in step 454), its value is monitored. Once the value of ABC has changed at least $1, the corresponding trading activity is executed.

In step 456, a predefined period of time passes. In step 458 it is determined whether the defined interest has experienced the value delta, i.e., whether the defined interest has changed in value an amount at least equal to the value delta. If the value delta has been experienced, then control flows to step 460. Otherwise, control flows back to step 456.

In step 456, the trading activity of the then-portion of the if-then statement is executed, thereby assuming an initial position in the market. A position is generally considered taking ownership of an “interest,” as defined above. For example, the then-statement may comprise a command to purchase a certain number of shares of a particular stock or a certain amount of a currency.

It should be noted that the trading activity of the then-portion of an if-then statement of the investment strategy definition 111 may depend on the direction (negative or positive) in which the value delta has been experienced. The trading activity of the then-portion of an if-then statement may state that if the value delta has been experienced in a negative direction, then a first trading activity is executed. But if the value delta has been experienced in a positive direction, then an opposite trading activity is executed. For example, an if-then statement may state that if stock ticker symbol ABC increases in value $1, then a purchase of a call option on the stock is executed. If stock ABC, however, decreases in value $1, then a purchase of a put option on the stock is executed.

FIGS. 5A and 5B is a flow chart that shows the control flow of a more specific process for providing management of hedging activities over a communications network, in accordance with one embodiment of the present invention. The process shown in FIGS. 5A and 5B provide more detail on the general processes shown in steps 210 through 216 of FIG. 2.

In step 512, the program logic 155 continuously reads the market data received from market 145 and/or market data provider 150 and attempts to: a) match the market data to the if-portions of the if-then statements of the first level of hedging action, as defined in the hedge definitions, and b) match the market data to the if-portions of the if-then statements of the terminators actions.

The if-portion of the first-level hedging action, i.e., the trigger point, may describe a target price or value of the interest of the initial position of step 208. This target price or value can be a predefined percent of the distance between the current price of the interest (of the initial position of step 208) and the maximum tolerated loss (i.e., the stop loss point) for that interest (as defined by user 130 in definition 111). In a first example, say the current price of the interest is $100 per share, the user owns one share, and the user 130 defined $50 as the maximum tolerated loss for that position. The trigger point may be 50% of the distance between the current price of the interest ($100 per share) and the maximum tolerated loss for that interest ($50 per share), which is $75 per share. Thus, when the interest reaches $75 per share, which equals 50% of the distance between the current price and the maximum tolerated loss, this triggers a corresponding first-level hedging action. The user 130 may predefine trigger points, the percentage of the distance between prices, maximum tolerated loss, etc. in the definition file 111.

A hedge is an investment position intended to offset potential losses that may be incurred by a companion investment. Thus, a hedging action entails taking a hedge position that is typically opposite to the position being hedged. In the first example above, the first level hedging action would be, for example, to short sale an equal value of a stock considered to be a competitor of the stock of the initial position.

The trigger point can alternatively be a predefined percent of the distance between the current price of the interest (of the initial position of step 208) and the maximum tolerated gain (i.e., the take profit point) for that interest (as defined by user 130 in definition 111). In a second example, say the current price of the interest is $100 per share, the user owns one share, and the user 130 defined $50 as the maximum tolerated gain for that position. The trigger point may be 50% of the distance between the current price of the interest ($100 per share) and the maximum tolerated gain for that interest ($150 per share), which is $125 per share. Thus, when the interest reaches $125 per share, which equals 50% of the distance between the current price and the maximum tolerated gain, this triggers a corresponding first-level hedging action, which may be different from the first-level hedging action taken if the interest gains in price, as described above (i.e., a long position is taken in an equal value of the stock). Alternatively, the first-level hedging action taken in this case may be the same as the first-level hedging action taken if the interest gains in price, as described above.

In step 514, the program logic 155 determines whether: a) a match is made between the market data (pertaining to the initial position) and the if-portions of the if-then statements of the first level of hedging action or b) a match is made between the market data and the if-portions of the if-then statements of the terminator action. If a match is made to the first level of hedging action, the control flows to step 516. If a match is made to the terminator action, the control flows to step 550. Otherwise, control flows back to step 512.

In step 516, a match was made between the market data and the triggering event(s) of the first-level hedging action, and therefore program logic 155 executes the first-level hedging action, thereby assuming a first-level hedge position in the market, wherein the first-level hedge position is calculated to hedge the initial position of step 208. At least one of the calculations made in calculating the first-level hedging position is to calculate the amount or size of the first-level hedging position, which may be based at least on the size of (or monetary amount and/or number of shares of) the initial position of step 208. The amount or size of the first-level hedging position may further be based on any of the data entered by the user 130 in definition 111 and/or the data in the hedge definition.

In step 518, the program logic 155 continuously reads the market data received from market 145 and/or market data provider 150 and attempts to: a) match the market data to the scenario(s) that act as the triggering event(s) for a second level of hedging action, as defined in the hedge definitions, and b) match the market data to the if-portions of the if-then statements of the terminators actions.

In step 520, the program logic 155 determines whether: a) a match is made between the market data (pertaining to the first level hedge position) and the if-portions of the if-then statements of the second level of hedging action or b) a match is made between the market data to the if-portions of the if-then statements of the terminator action. If a match is made to the second level of hedging action, the control flows to step 522. If a match is made to the terminator action, the control flows to step 550. Otherwise, control flows back to step 518.

In step 522, a match was made between the market data and the triggering event(s) of the second-level hedging action, and therefore program logic 155 executes the second-level hedging action, thereby assuming a second-level hedge position in the market, wherein the second level hedging position hedges the first level hedging position taken in step 516. A second-level hedging action is similar to a first-level hedging action except that the second level hedge position seeks to hedge the first level hedge position. A second-level hedging action is further calculated similarly to a first-level hedging action (i.e., it is based on the character and specifics, such as the size and monetary amount of, the first-level hedging action).

In step 524, the program logic 155 continuously reads the market data received from market 145 and/or market data provider 150 and attempts to: a) match the market data to the scenario(s) that act as the triggering event(s) for a third level of hedging action, as defined in the hedge definitions, and b) match the market data to the if-portions of the if-then statements of the terminators actions.

In step 526, the program logic 155 determines whether a) a match is made between the market data (pertaining to the second level hedge position) and the if-portions of the if-then statements of the third level of hedging action or b) a match is made between the market data to the if-portions of the if-then statements of the terminator action. If a match is made to the third level of hedging action, the control flows to step 528. If a match is made to the terminator action, the control flows to step 550. Otherwise, control flows back to step 524.

In step 528, a match was made between the market data and the triggering event(s) of the third-level hedging action, and therefore program logic 155 executes the third-level hedging action, thereby assuming a third-level hedge position in the market, wherein the third level hedging position hedges the second level hedging position. A third-level hedging action is similar to a second-level hedging action except that the third level hedge position seeks to hedge the second level hedge position. A third-level hedging action is further calculated similarly to a second-level hedging action.

In step 530, the program logic 155 continuously reads the market data received from market 145 and/or market data provider 150 and attempts to: a) match the market data to the scenario(s) that act as the triggering event(s) for a fourth level of hedging action, as defined in the hedge definitions, and b) match the market data to the if-portions of the if-then statements of the terminators actions.

In step 532, the program logic 155 determines whether: a) a match is made between the market data (pertaining to the third level hedge position) and the if-portions of the if-then statements of the fourth level of hedging action or b) a match is made between the market data to the if-portions of the if-then statements of the terminator action. If a match is made to the fourth level of hedging action, the control flows to step 534. If a match is made to the terminator action, the control flows to step 550. Otherwise, control flows back to step 530.

In step 534, a match was made between the market data and the triggering event(s) of the fourth-level hedging action, and therefore program logic 155 executes the fourth-level hedging action, thereby assuming a fourth-level hedge position in the market, wherein the fourth level hedging position hedges the third level hedging position. A fourth-level hedging action is similar to a third-level hedging action except that the fourth level hedge position seeks to hedge the third level hedge position. A fourth-level hedging action is further calculated similarly to a third-level hedging action.

In step 536, the program logic 155 continuously reads the market data received from market 145 and/or market data provider 150 and attempts to: a) match the market data to the scenario(s) that act as the triggering event(s) for a fifth level of hedging action, as defined in the hedge definitions, and b) match the market data to the if-portions of the if-then statements of the terminators actions.

In step 538, the program logic 155 determines whether: a) a match is made between the market data (pertaining to the fourth level hedge position) and the if-portions of the if-then statements of the fifth level of hedging action or b) a match is made between the market data to the if-portions of the if-then statements of the terminator action. If a match is made to the fifth level of hedging action, the control flows to step 540. If a match is made to the terminator action, the control flows to step 550. Otherwise, control flows back to step 536.

In step 540, a match was made between the market data and the triggering event(s) of the fifth-level hedging action, and therefore program logic 155 executes the fifth-level hedging action, thereby assuming a fifth-level hedge position in the market, wherein the fifth level hedging position hedges the fourth level hedging position. A fifth-level hedging action is similar to a fourth-level hedging action except that the fifth level hedge position seeks to hedge the fourth level hedge position. A fifth-level hedging action is further calculated similarly to a fourth-level hedging action.

In step 550, a match was made between the market data and the triggering event(s) of the terminator action, and therefore program logic 155 executes the exit of the initial position in step 208 and any intervening hedge positions that may have been taken in steps 516, 522, 528, 534 and/or step 540. Exiting a position may comprise a transaction wherein ownership of an interest is sold or transacted in another step. The if-portion of the terminator action, i.e., the trigger point, may describe a target price or value of any of the interests of the initial position of step 208 and any intervening hedge positions that may have been taken in steps 516, 522, 528, 534 and/or step 540. The target price or value can be a predefined percent of the distance between the current price of the interest (of any or some of the positions defined above) and the maximum tolerated loss or gain for that interest (which may be defined by user 130 in definitions 111).

FIG. 5C is a flow chart that shows the control flow of a process for providing automated management of stop loss and/or take profit trading activities over a communications network, in accordance with one embodiment of the present invention. The process shown in FIG. 5C provides generally more detail on the processes of monitoring and managing a first position so as to optimize gain and minimize loss, after the first position is taken, as shown in step 208 of FIG. 2. Note that prior to the steps of FIG. 5C, the server 102 has received and stored historical market data pertaining to open-close values of the interest of the initial position or any other position (see step 202 of FIG. 2 above).

FIG. 5C starts with the definition of certain data in step 580. First, a take profit value and/or a stop loss value for an initial position are defined. Recall a stop loss is an order or plan to sell a financial interest when it reaches a certain price and a take profit is an order or plan specifying a price from the current price point where to close out a current position for a profit. A stop loss value is the price or value of the current position at which it will be sold or closed out. Similarly, a take profit value is the price or value of the current position at which it will be sold or closed out.

Also in step 580, a threshold value (of a probability that the open-close value of the interest of a position reaches the take profit value or stop loss value within a predefined period of time, according to the current acceleration rate for the open-close value of the interest) is defined. The threshold value is explained in greater detail below. Also in step 580, a number of data values N in the past that will be considered when determining whether a current open-close value is an outlier is defined. The number of data values N may be defined as a number or as a time period, such as a given number of days, wherein the number of data values in that time period is taken as N. When calculating whether a current open-close value of an interest is an outlier, the value is compared, for example, to a data group of open-close values of the interest. The data group and number of data values N is explained in greater detail below.

Also in step 580, a distance value D (of a distance of a data group element to a current open close value) is defined. When calculating whether a current open close value of an interest is an outlier, D is a predefined difference value that denotes the difference between a data group element and a current open close value. Also defined in step 580 is a percentage p, wherein if the percentage of data group elements with a difference value D is greater than the given percentage value p, then the current open-close value is an outlier. This is discussed in greater detail below.

In one embodiment of the present invention, step 580 is conducted by a user, such as investor 130, interacting with a graphical user interface that allows for input of data into the interface. In another embodiment, step 580 is conducted by investor 130 interacting with a computer program, such as logic 155, wherein the computer program may offer data or information (such as historical data values, graphs, histograms, recommendations, values chosen by others, etc.) to the investor 130 that aid the investor 130 in making decisions as to the values being entered.

In step 581, market data (sent from market data provider 150 or market 145) is continually read by program logic 155, such as in real time. The market data may include, for example, the current open-close value of the interest of the initial position or the current position of the investor 130. In step 582, the program logic 155 calculates whether the current open-close value of the interest is an outlier. In one embodiment, the calculation of step 582, which comprises determining the current open-close value of the interest is an outlier, is performed as follows:

calculate n/N, wherein

$$n = {\sum }_{i = 1}^{N} S ( {x}_{i} ) \{ \begin{matrix}\vert {x}_{N + 1} - {x}_{i} \vert > D : S ( {x}_{i} ) = 1 \\ \vert {x}_{N + 1} - {x}_{i} \vert \leq D : S ( {x}_{i} ) = 0\end{matrix} \}$$

wherein xᵢ for i=1 to i=N comprises a data group of open-close values of the interest, N is a total number of values in the data group, and D is a predefined difference value, such that if n/N is greater than a given percentage value p, then the current open-close value is an outlier. If the calculation of step 582 results in a determination that the open close value is an outlier, the control flows to step 583. Otherwise, control flows back to step 581, wherein the next open close value of the interest is evaluated.

In step 583, program logic 155 calculates the acceleration of the current open-close value (x_{N+1}) of the interest is calculated. The acceleration calculation is performed as follows:

current acceleration=(change in velocity)/(change in time)

OR

current acceleration=(V_{final}−Vᵢₙᵢₜᵢₐₗ)/(t_{final}−tᵢₙᵢₜᵢₐₗ)

wherein V_{final} and Vᵢₙᵢₜᵢₐₗ are velocity values ad velocity at any given time is calculated as:

current velocity=(change in price)/(change in time)

OR

current velocity=(p_{final}−pᵢₙᵢₜᵢₐₗ)/(t_{final}−tᵢₙᵢₜᵢₐₗ)

wherein tᵢₙᵢₜᵢₐₗ is the initial time at the start of a velocity or acceleration calculation, t_{final} is the time at the end of the calculation, Vᵢₙᵢₜᵢₐₗ is the initial velocity at the time of an acceleration calculation, V_{final} is the final velocity at the time of an acceleration calculation, pᵢₙᵢₜᵢₐₗ is the initial open-close price at the start of a calculation of velocity and p_{final} is the final open-close price at the start of a calculation of velocity. The time frame over which velocity and acceleration are calculated may vary and are adjustable by the user 130.

In step 584, the program logic 155 calculates the direction of the current acceleration of the open-close value of the interest. Specifically, the program logic 155 calculates whether open-close value of the interest is moving towards the stop loss value of the interest (i.e., in a downwards direction) or the take profit value of the interest (i.e., in an upwards direction). In step 585, the program logic 155 calculates the probability that the open-close value of the interest will reach the stop loss value of the interest or the take profit value of the interest, according to the current acceleration of the open-close value of the interest.

In one embodiment, the calculation of step 585 is performed as follows. First, the program logic 155 calculates an estimated time period wherein the open-close value of the interest will reach the take profit value or stop loss value, according to the current acceleration rate. Calculating the aforementioned time period is based on the current open-close value of the interest, the current velocity of the open close value of the interest, and the current acceleration of the open close value of the interest. The time period calculation may also take into account the following data: historical market data, historical acceleration and velocity data for the interest and metadata pertaining to the acceleration and velocity data for the interest.

Second, the program logic 155 calculates a probability of the open-close value of the interest reaching the take profit value or stop loss value within the estimated time period based on historical market data. The probability calculation may also take into account the following data: historical market data, historical acceleration and velocity data for the interest, metadata pertaining to the acceleration and velocity data for the interest, news data, volatility data, and metadata about news data and volatility data (as defined above).

In step 586, the program logic 155 determines whether the probability that the open-close value of the interest reaches the take profit value or stop loss value within the estimated period of time is greater than a threshold value. In one embodiment, the threshold value may have been defined by the user 130, by program logic 155 or via a collaboration of the two. If the result of step 586 is that the probability is greater than the threshold value, then control flows to step 587. Otherwise, control flows back to step 581.

In step 587, the program logic 155 transmits to the user 130 an alert that the probability that the open-close value of the interest reaches the take profit value or stop loss value within the predefined period of time is greater than the threshold value. The alert may be an email, text message, phone call, user interface visual indicia, report or the like. In response to the alert, if the probability that the open-close value of the interest reaches the take profit value within the predefined period of time is greater than the threshold value, then the user 130 may adjust the take profit value upwards so as to account for the probability information provided and optimize gains. Doing so will result in the realization of a larger profit than allowing the initial take profit value to remain.

Alternatively, in response to the alert, if the probability that the open-close value of the interest reaches the stop loss value within the predefined period of time is greater than the threshold value, then the user 130 may adjust the stop loss value upwards so as to account for the probability information provided and minimize losses. Doing so will result in the realization of a smaller loss than allowing the initial stop loss value to remain.

Alternatively, in step 587, the program logic 155 adjusts the take profit value or stop loss value based on the probability. For example, the amount the take profit value or stop loss value is changed may be proportional to the probability value. In another alternative, in step 587, the program logic 155 effectuates the exiting of the initial position based on the probability. For example, the price asked for any interest sold or exited may be proportional to the probability value.

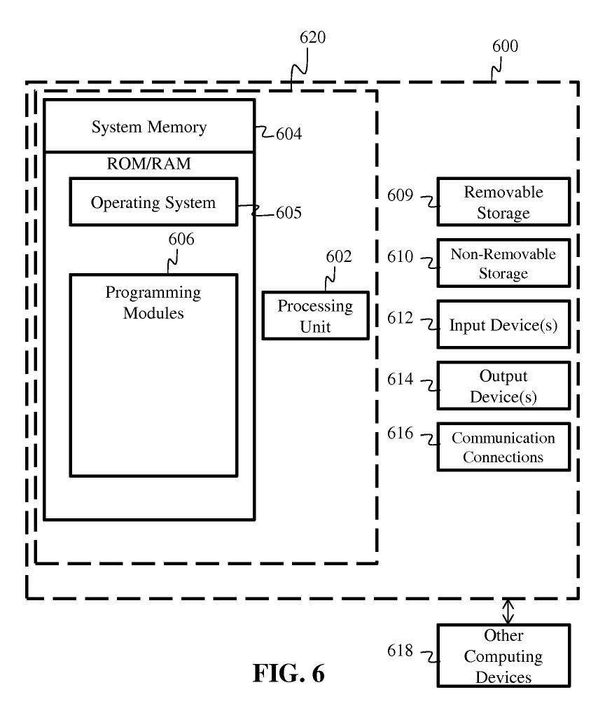

FIG. 6 is a block diagram of a system including an example computing device 600 and other computing devices. Consistent with the embodiments described herein, the aforementioned actions performed by clients 120, 130, 140 and 150 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for the methods of FIGS. 2 through 5C as described above. The methods of FIGS. 2 through 5C may operate in other environments and are not limited to computing device 600.

With reference to FIG. 6, a system consistent with an embodiment of the invention may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination or memory. System memory 604 may include operating system 605, one or more programming modules 606. Operating system 605, for example, may be suitable for controlling computing device 600's operation. In one embodiment, programming modules 606 may include program modules for performing the actions described in the methods of FIGS. 2 through 5C. Furthermore, embodiments of the invention may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 may perform processes including, for example, one or more of the methods of FIGS. 2 through 5C as described above. The aforementioned processes are examples, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method on a computer for performing automated trading activities, comprising:
defining a take profit value and/or stop loss value for an initial position comprising an interest having an open-close value;
receiving and storing historical market data pertaining to the initial position;
receiving current market data pertaining to the initial position;
determining, according to the current market data and the historical market data, that a current open-close value of the interest is an outlier;
determining, according to the current acceleration rate for the open-close value and the take profit value or stop loss value, a probability that an open-close value of the interest reaches the take profit value or stop loss value within a predefined period of time, wherein the probability is greater than a threshold value; and
transmitting an alert that the probability that the open-close value of the interest reaches the take profit value or stop loss value within the predefined period of time is greater than the threshold value.

2. The method of claim 1, wherein the step of transmitting an alert further includes adjusting the take profit value or stop loss value based on the probability.

3. The method of claim 1, wherein the step of transmitting an alert further includes exiting the initial position.

4. The method of claim 2, wherein the step of defining a take profit value or stop loss value further includes defining the threshold value.

5. The method of claim 2, wherein the step of determining that a current open-close value (x_{N+1}) of the interest is an outlier comprises calculating n/N, wherein
$$n = {\sum }_{i = 1}^{N} S ( {x}_{i} ) \{ \begin{matrix}\vert {x}_{N + 1} - {x}_{i} \vert > D : S ( {x}_{i} ) = 1 \\ \vert {x}_{N + 1} - {x}_{i} \vert \leq D : S ( {x}_{i} ) = 0\end{matrix} \}$$
wherein xᵢ for i=1 to i=N comprises a data group of open-close values of the interest, N is a total number of values in the data group, and D is a predefined difference value, such that if n/N is greater than a given percentage value p, then the current open-close value is an outlier.

6. The method of claim 2, wherein the step of defining a take profit value or stop loss value further includes defining N, D and the given percentage value p.

7. The method of claim 5, wherein the step of determining a probability that an open-close value of the interest reaches the take profit value or stop loss value comprises:
calculating an estimated time period wherein the open-close value of the interest will reach the take profit value or stop loss value, according to the current acceleration rate; and
calculating a probability of the open-close value of the interest reaching the take profit value or stop loss value within the estimated time period based on historical market data.

8. The method of claim 2, wherein the step of transmitting an alert further comprises transmitting an email or text message to an owner of the initial position.

9. A computer system for performing automated trading activities, the system comprising:
a network connection device for receiving historical market data;
a memory storage for storing the historical market data; and
a processing unit coupled to the memory storage, when the processing unit is programmed for:
defining, in the memory storage, a take profit value and/or stop loss value for an initial position comprising an interest having an open-close value;
receiving, via the network connection device, current market data pertaining to the initial position;
determining, according to the current market data and the historical market data, that a current open-close value of the interest is an outlier;
determining, according to the current acceleration rate for the open-close value and the take profit value or stop loss value, a probability that an open-close value of the interest reaches the take profit value or stop loss value within a predefined period of time, wherein the probability is greater than a threshold value; and
transmitting, via the network connection device, an alert that the probability that the open-close value of the interest reaches the take profit value or stop loss value within the predefined period of time is greater than the threshold value.

10. The computer system of claim 9, wherein the step of transmitting an alert further includes adjusting the take profit value or stop loss value based on the probability.

11. The computer system of claim 9, wherein the step of transmitting an alert further includes exiting the initial position.

12. The computer system of claim 10, wherein the step of defining a take profit value or stop loss value further includes defining, in the memory storage, the threshold value.

13. The computer system of claim 10, wherein the step of determining that a current open-close value (x_{N+1}) of the interest is an outlier comprises calculating n/N, wherein
$$n = {\sum }_{i = 1}^{N} S ( {x}_{i} ) \{ \begin{matrix}\vert {x}_{N + 1} - {x}_{i} \vert > D : S ( {x}_{i} ) = 1 \\ \vert {x}_{N + 1} - {x}_{i} \vert \leq D : S ( {x}_{i} ) = 0\end{matrix} \}$$
wherein xᵢ for i=1 to i=N comprises a data group of open-close values of the interest, N is a total number of values in the data group, and D is a predefined difference value, such that if n/N is greater than a given percentage value p, then the current open-close value is an outlier.

14. The computer system of claim 10, wherein the step of defining a take profit value or stop loss value further includes defining, in the memory storage, N, D and the given percentage value p.

15. The computer system of claim 13, wherein the step of determining a probability that the open-close value of the interest reaches the take profit value or stop loss value comprises:
calculating an estimated time period wherein the open-close value of the interest will reach the take profit value or stop loss value, according to the current acceleration rate; and
calculating a probability of the open-close value of the interest reaching the take profit value or stop loss value within the estimated time period based on historical market data.

16. The computer system of claim 102, wherein the step of transmitting an alert further comprises transmitting, via the network connection device, an email or text message to an owner of the initial position.

17. A computer program product for performing automated trading activities, the computer program product comprising at least one computer readable storage medium having one or more computer readable program code portions stored therein, said computer readable program code portions comprising:
a first executable portion for defining a take profit value and/or stop loss value for an initial position comprising an interest having an open-close value;
a second executable portion for receiving and storing historical market data pertaining to the initial position;
a third executable portion for receiving current market data pertaining to the initial position;
a fourth executable portion for determining, according to the current market data and the historical market data, that a current open-close value of the interest is an outlier;
a fifth executable portion for determining, according to the current acceleration rate for the open-close value and the take profit value or stop loss value, a probability that an open-close value of the interest reaches the take profit value or stop loss value within a predefined period of time, wherein the probability is greater than a threshold value; and
a sixth executable portion for transmitting an alert that the probability that the open-close value of the interest reaches the take profit value or stop loss value within the predefined period of time is greater than the threshold value.
